(19) United States
(12) Patent Application Publication
(10) Pub. No.: US 2010/0077304 A1
(43) Pub. Date: Mar. 25, 2010

(54) Virtual Magnification with Interactive Panning

(75) Inventors: Nazia Zaman, Bellevue, WA (US); Paul J. Reid, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/233,771

(22) Filed: Sep. 19, 2008

(51) Int. Cl. G06F 3/041

(52) U.S. Cl. 715/702

(57) ABSTRACT

A magnification system is described that provides a better user experience to users of desktop magnification, such as in conjunction with touch-based interface devices. The system includes an interactive panning mode that allows users to pan a magnified area of the desktop or application while still interacting with magnified elements, such as icons, files, and so forth. In the interactive panning mode, the user can pan the magnified desktop in a manner similar to traditional panning by selecting an area of the magnified desktop that does not contain user interface elements. The user can also click/touch buttons, UI elements, and interact with the magnified desktop in a normal fashion.

### BACKGROUND

Screen magnifiers are a type of assistive technology used by visually impaired people with some functional vision. By magnifying areas of the screen, the screen magnifier allows people that would otherwise not be able to see areas of the screen that are too small to enlarge these areas. Screen magnifiers are software applications that present a computer's graphical output in an enlarged form. Many screen magnifiers act similar to a physical magnifying glass that a user can move around over the screen to magnify a specific area, except rather than a physical object the screen magnifier is software and the user moves the displayed glass or lens with the mouse or other input device. The most common method of magnification is to present an enlarged view of a portion of the original screen content that covers a portion of or the entire screen. The enlarged view often tracks the pointer or cursor as the user moves a mouse or other input device around the screen so that the user can magnify different areas. Screen magnifiers may work with a single application or across multiple applications at the operating system level. For example, Microsoft Windows Vista includes Magnifier, an application for magnifying the entire desktop and any applications displayed on it.

A tablet PC, or pen computer, is a notebook or slate-shaped mobile computer, equipped with a touch screen or graphics tablet/screen hybrid technology that allows the user to operate the computer with a stylus, digital pen, or fingertip instead of a keyboard or mouse. Tablet PCs offer a more natural form of input, as sketching and handwriting are a much more familiar form of input than a keyboard and mouse, especially for people who are new to computers. Tablet PCs can also be more accessible because those who are physically unable to type can utilize the additional features of a tablet PC to be able to interact with the electronic world. Applications often do not know they are running on a tablet PC, and the operating system may attempt to provide input to applications that appears similar to mouse input. This can cause several problems for screen magnifiers used in conjunction with tablet PCs or other touch-based interface devices.

One problem is that touch-based interface devices do not distinguish between setting the pen down to move it (e.g., panning a magnification area) and tapping the screen to click an object (e.g., selecting an icon). The same problem occurs even with a mouse, where a click could be a click of a button or a click to grab the desktop and pan. To resolve this ambiguity, some applications have an exclusive panning mode (e.g., often represented by a hand icon) that informs the application to interpret movements of the pen or other device as panning movements, when selected. In this mode, the application locks the display area to the cursor position and moves the display area as the user moves the cursor to perform panning. However, this type of panning mode prevents the user from performing activities other than panning, such as clicking on or interacting with user interface elements, until the user leaves the exclusive panning mode. When not in this mode, the user can click on and select objects with a pen, but cannot pan. The user is either in one mode or in the other and must take extra steps to switch modes.

### SUMMARY

A magnification system is described that provides a better user experience to users of desktop magnification, such as in conjunction with touch-based interface devices. The magnification system receives information about the current location of the cursor and determines whether there are user interface elements with which the user can interact near the cursor. If there are nearby user interface elements, then the system infers a selection action, such as a touch of the screen with a pen or fingertip, to communicate the user's intent to interact with the user interface element. If there are no nearby user interface elements, then the system interprets a selection action to communicate the user's intent to pan the display, and if the user then moves the pen or other input device, the system pans the magnified area of the display based on the direction of the movement. Thus, the magnification system allows the user to pan the magnified area and interact with user interface elements without changing modes or performing other additional steps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates the components of the magnification system, in one embodiment.

FIG. 2 is a display diagram that illustrates an operating environment of the magnification system, in one embodiment.

FIG. 3 is a flow diagram that illustrates the steps performed by the components of the system to distinguish panning from selection in a virtual magnifier that magnifies an operating system desktop, in one embodiment.

FIG. 4 is a flow diagram that illustrates the steps performed by the components of the system to indicate to a user the effect of selecting a particular displayed area, in one embodiment.

### DETAILED DESCRIPTION

A magnification system is described that provides a better user experience to users of desktop magnification, such as in conjunction with touch-based interface devices. The system includes an interactive panning mode that allows users to pan a magnified area of the desktop or application while still interacting with magnified elements, such as icons, files, and so forth. In the interactive panning mode, the user can pan the magnified desktop in a manner similar to traditional panning by selecting an area of the magnified desktop that does not contain user interface elements. The user can scroll the desktop by simply dragging the visible surface. When the user touches the stylus to the screen and drags the pen, or clicks the mouse button and drags the mouse, or touches the screen and drags the finger, the system scrolls the desktop by the amount the finger/stylus/cursor moves. While in the interactive panning mode, the user can also click/touch buttons, UI elements, and interact with the magnified desktop in a normal fashion.

The magnification system receives information about the current location of the cursor and determines whether there are user interface elements with which the user can interact near the cursor. If there are nearby user interface elements, then the system infers a selection action, such as a touch of the screen with a pen or fingertip, to communicate the user's intent to interact with the user interface element. For example, if the user clicks a button, the system passes the click on to the button. If there are no nearby user interface elements, then the system interprets a selection action to communicate the user's intent to pan the display, and if the user then moves the pen or other input device, the system pans the magnified area of the display based on the direction of the movement. Thus, the magnification system allows the user to pan the magnified area and interact with user interface elements without changing modes or performing other additional steps.

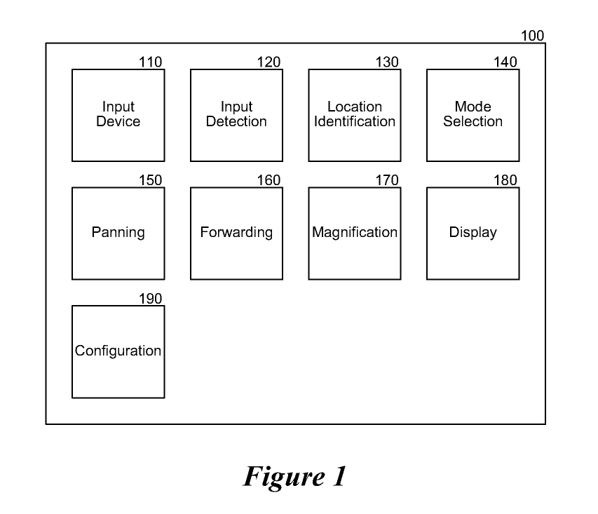

FIG. 1 is a block diagram that illustrates the components of the magnification system, in one embodiment. The magnification system 100 includes at least one input device 110, an input detection component 120, a location identification component 130, a mode selection component 140, a panning component 150, a forwarding component 160, a magnification component 170, a display 180, and a configuration component 190. Each of these components is described in further detail herein.

The input device 110 is configured to receive input from a user and communicate the input to an operating system. The input device can be a variety of devices such as a stylus, digital pen, mouse, or even the user's finger moving over a touch screen. The input detection component 120 is configured to convert the received input into coordinates of a displayed cursor. When a user moves the input device 110, the input detection component 120 moves the displayed cursor. The location identification component 130 is configured to identify one or more user interface elements present at a current location of the displayed cursor. For example, the location identification component 130 may determine that the current location of the cursor is over a button that the user can press with the input device 110. As another example, the location identification component 130 may determine that the current location of the cursor is not over any user interface elements, such as when the cursor is over an empty portion of the desktop or a blank area of a document.

The mode selection component 140 is configured to select between an interaction mode and a panning mode based on the current location of the cursor and any identified user interface elements at the current location of the cursor. The mode selection component 140 determines how the system will interpret subsequent actions of the user. For example, if the mode selection component 140 selects the interaction mode, then the system 100 forwards at least some subsequent actions of the user on to the identified user interface elements. If the mode selection component 140 selects the panning mode, then the system 100 interprets subsequent actions, such as dragging the input device 110 to a new location, as a panning action and updates the magnified area of the display.

The panning component 150 is configured to pan an area of the display that the magnification system is magnifying when the mode selection component selects the panning mode. The panning component stores the coordinates of the display area that the system is currently magnifying and modifies the coordinates based on movement to pan the magnified area. The panning component 150 may apply scaling based on a magnification factor so that the user's movement within the magnified area does not pan the display faster than typically expected by the user. For example, if the magnification factor is set at 16 times magnification, then the mouse cursor on screen may appear to move much faster than the user would want to pan.

The forwarding component 160 is configured to pass received user input to the identified user interface elements when the mode selection component selects the interaction mode. For example, the forwarding component 160 may pass along clicks of a mouse or taps of a stylus to buttons or other user interface elements. The forwarding component 160 may pass these messages as standard messages familiar to the application, such as a mouse button down message (e.g., WM_LBUTTONDOWN on Microsoft Windows).

The display 180 is configured to display a graphical representation of one or more applications and a magnified view of at least a portion of the graphical representation. For example, the display 180 may display a desktop of the operating system and applications that are currently running as windows on the desktop. The user may select an area of the graphical representation that the system 100 will magnify by panning the magnified area. The magnification component 170 is configured to generate the magnified view from a selected area of the graphical representation. When the user pans the magnified area, the panning component 150 provides the coordinates of the new area to be magnified to the magnification component 170, and the magnification component performs standard graphical operations, such as a stretch blit, to display a larger than usual view of the selected area.

The configuration component 190 is configured to receive configuration information from the user. For example, the user may turn off the interactive panning mode so that the mode selection component 140 does not do any panning, but rather allows the user to interact with an application in a traditional way. When the user turns the interactive panning mode back on, the mode selection component 140 behaves as described herein.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

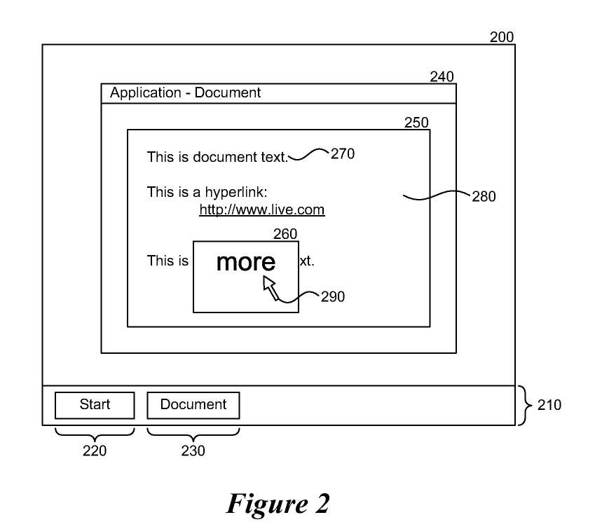

FIG. 2 is a display diagram that illustrates an operating environment of the magnification system, in one embodiment. The environment includes a typical desktop 200 that contains an operating system menu 220, a button 230 for activating one or more running applications, and one or more application windows, such as application window 240. The application window 240 illustrates a typical document-based application (e.g., Microsoft Word or Microsoft Internet Explorer) that contains a document display area 250. The document display area 250 contains regions, such as region 270, that contain text or other user interface elements that are meaningful to the application, as well as empty areas, such as region 280 where there is no text or other user interface element. The desktop 200 also includes a magnified view 260 that displays a portion of the desktop 200 at a larger than normal size. For example, the sentence under the magnified view 260 says, “This is more text,” and the magnified view 260 shows a larger than normal display of the word “more.” Using the magnification system described herein, if the user clicks or touches the display while the cursor 290 is over an empty area of the screen, such as region 280, then movement of the cursor by the user will pan the magnified area 260 to a different portion of the desktop 200. If instead the user clicks or touches the display while the cursor 290 is over an area with user interface elements, such as button 230 or region 270, then the system will forward the user's action to the application or operating system to handle in a traditional manner. In this way, the user can pan and interact with the operating system and applications without manually switching modes.

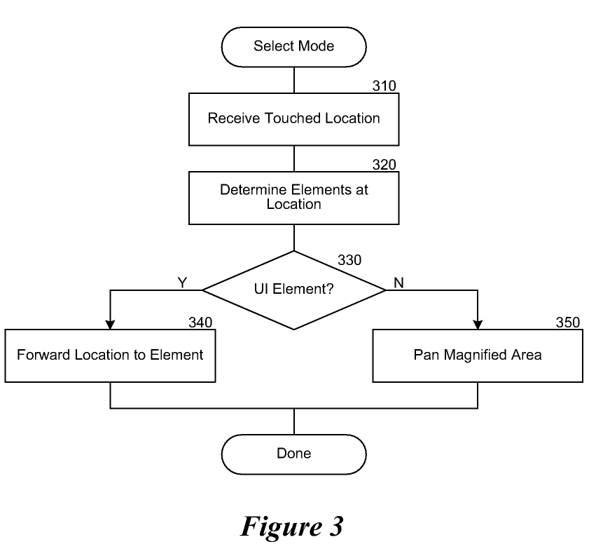

FIG. 3 is a flow diagram that illustrates the steps performed by the components of the system to distinguish panning from selection in a virtual magnifier that magnifies an operating system desktop, in one embodiment. In block 310, the system receives a location of the desktop touched by a touch-based input device, such as a digital pen. For example, a user may tap a button or empty area of a desktop displayed on a touch screen. In block 320, the system determines whether the touched location contains a user interface element with which the user can interact. For example, the touched location may contain a hyperlink, list box, toolbar button, or other user interface element. In decision block 330, if the touched location contains a user interface element, then the system continues at block 340, else the system continues at block 350. The system may also interpret a click on a user interface element as an instruction to pan if dragging occurs during the click. For example, if a mouse down happens over a clickable element like a link, but the mouse up happens somewhere else (e.g., a drag) that can also instruct the system to pan. In block 340, if the touched location contains a user interface element with which the user can interact, the system forwards the touched location to the user interface element. For example, if the user clicked on a button, then the system forwards to the click to the button for processing. In block 350, if the touched location does not contain a user interface element with which the user can interact, the system pans a magnified portion of the display based on user movement of the touch-based input device. For example if the user sets a stylus down on the display and drags to the right, then the system pans the magnified view to the right.

The magnification system can determine the user interface elements with which a user can interact in a variety of ways. For example, the operating system may provide a user interface automation API that allows applications to query attributes of a user interface. Microsoft .NET 3.0 and Microsoft Windows Vista provide such an API, through which an application can determine that, for example, an item is invokable. This may include a button that a user can click, a hyperlink that a user can select, a scrollbar that a user can click to scroll through a document, and so forth. As another example, the magnification system may detect when the cursor changes to a different icon.

Many applications modify the cursor icon to indicate to a user the effect of clicking or taking other actions at the current cursor location. For example, document-based applications may have a selection cursor (e.g., a selection arrow), a text insertion cursor (e.g., an I-beam), and a scroll cursor (e.g., a downward- or upward-pointing arrow). The magnification system can define the cursor types that the system will interpret as not containing user interface elements, and when a user selects these locations, the system allows the user to pan.

In addition, operating systems often provide a common control library, through which the magnification system can intercept information about the current location of the cursor. For example, many common control libraries provide buttons, list boxes, edit boxes, and so forth, and when the cursor is over one a particular location, the system can infer whether the user wants to interact with the control or pan the magnified area.

In some embodiments, an application is unaware of the magnification systems actions to pan or forward along user selection information. For example, when the system determines that the user wants to pan, the system may pass the application a standard drag message or not inform the application at all. On the other hand, when the system determines that the user wants to interact with an element of the application, then the system may forward a message, such as a standard mouse button down message, to the application that to the application looks like a standard mouse click. In this way, the application receives familiar indications, such as mouse clicks, of the user's actions and is unaware that the magnification system is intercepting messages and providing additional functionality before the messages reach the application.

In some embodiments, the magnification system forwards information about the touched location based on the type of user interface element. The touched location can contain many different types of user interface elements. For example, if the touched location contains an application button, then the system forwards a message to the application indicating that the user clicked the button. If the touched location contains a hyperlink, then the system forwards a message to the application indicating that the user selected the hyperlink. The touched location may be within the area covered by an application window or outside of an application over a desktop displayed by the operating system. The magnification system allows the user's selection to pass through to the appropriate application or the operating system.

In some embodiments, the magnification system allows the user to configure the current mode of the system. For example, a user may turn on or off the interactive panning mode described herein. When the mode is off, the system does not pan the magnified area, even when the user selects an empty area of the display. When the mode is on, the system allows both panning and interaction with user interface elements as described herein. The magnification system may present configuration options to the user through a dialog box or magnification toolbar that the system displays when the system is actively magnifying an area of the display.

In some embodiment, the magnification system may display a special cursor to indicate to a user that selecting a particular area will cause panning rather than interaction with other user interface elements. For example, the system may display the common panning hand or another icon when the cursor is not located over a user interface element to inform the user that moving the pen or other input device at that location will cause the magnified area to pan in the direction the user moves. When the cursor is over a user interface element, then the system displays whatever cursor the application or operating system has requested to display, such as the common arrow or a text insertion cursor.

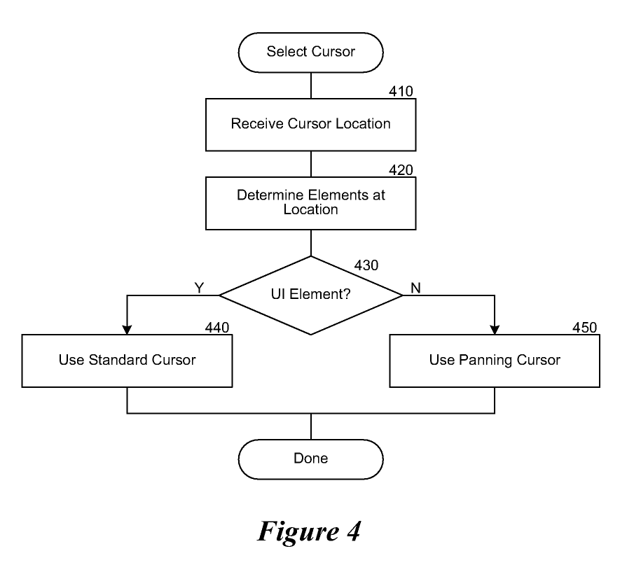

FIG. 4 is a flow diagram that illustrates the steps performed by the components of the system to indicate to a user the effect of selecting a particular displayed area, in one embodiment. In block 410, the system receives a location of the cursor, such as where a user last tapped a digital pen, or the location a user left the mouse hovering. For example, a user may have tapped a button or empty area of a desktop displayed on a touch screen and then lifted the pen. In block 420, the system determines whether the cursor location is over a user interface element with which the user can interact. For example, the cursor location may contain a scroll bar or an empty area of the desktop. In decision block 430, if the cursor is near a user interface element, then the system continues at block 440, else the system continues at block 450. The system may determine when the cursor is near an element in various ways that will be recognized by those of ordinary skill in the art. For example, the system may set a threshold distance between an edge of the cursor (or bounding box of the cursor) and an edge of the user interface element. Alternatively or additionally, the system may determine the distance between the centers of the cursor and user interface element, or determine whether the cursor overlaps any portion of the user interface element.

In block 440, if the cursor location is near a user interface element with which the user can interact, the system modifies the cursor icon to display an interaction cursor. For example, the system may determine the cursor icon that the operating system or application would currently be displaying in absence of the magnification system. In block 450, if the cursor location is not near a user interface element with which the user can interact, the system modifies the cursor to display a panning cursor to indicate to the user that the user can pan the magnified area. For example, the system may display a common panning hand icon or other similar indicator to the user.

From the foregoing, it will be appreciated that specific embodiments of the magnification system have been described herein for purposes of illustration, but that various modifications may be made without deviating from the spirit and scope of the invention. Accordingly, the invention is not limited except as by the appended claims.

I/We claim:

1. A computer-implemented method for distinguishing panning from selection in a virtual magnifier that magnifies an operating system desktop, the method comprising:
receiving a location of the desktop touched by a touch-based input device;
determining whether the touched location contains a user interface element with which the user can interact;
if the touched location contains a user interface element with which the user can interact, forwarding the touched location to the user interface element;
if the touched location does not contain a user interface element with which the user can interact, panning a magnified portion of the display based on user movement of the touch-based input device.

2. The method of claim 1 wherein the touched location contains a button, and wherein forwarding the touched location comprises sending a message to an application indicating that the user clicked the button.

3. The method of claim 1 wherein the touched location contains a hyperlink, and wherein forwarding the touched location comprises sending a message to an application indicating that the user selected the hyperlink.

4. The method of claim 1 wherein determining if the touched location contains a user interface element with which the user can interact comprises determining whether the touched location is an empty area of a document.

5. The method of claim 1 wherein determining if the touched location contains a user interface element with which the user can interact comprises determining whether an application window is covering the desktop at the touched location.

6. The method of claim 1 wherein determining whether the touched location contains a user interface element with which the user can interact comprises querying a user interface automation API to determine whether the touched area contains an invokable element.

7. The method of claim 1 wherein determining whether the touched location contains a user interface element with which the user can interact comprises determining the cursor type at the touched location.

8. The method of claim 1 wherein determining whether the touched location contains a user interface element with which the user can interact comprises determining whether the touched location contains a common control provided by the operating system.

9. The method of claim 1 wherein forwarding the touched location to the user interface element comprises forwarding a mouse button down message.

10. A computer system for selecting a displayed area to magnify, the system comprising:
an input device configured to receive input from a user and communicate the input to an operating system;
an input detection component configured to convert the received input into coordinates of a displayed cursor, wherein when a user moves the input device, the input detection component moves the displayed cursor;
a location identification component configured to identify one or more user interface elements present at a current location of the displayed cursor;
a mode selection component configured to select between an interaction mode and a panning mode based on the current location of the cursor and any identified user interface elements at the current location of the cursor;
a display configured to display a graphical representation of one or more applications and a magnified view of at least a portion of the graphical representation; and
a magnification component configured to generate the magnified view from a selected area of the graphical representation.

11. The system of claim 10 wherein the mode selection component further comprises:
a panning component configured to pan an area of the display that is magnified when the mode selection component selects the panning mode; and
a forwarding component configured to pass received user input to the identified user interface elements when the mode selection component selects the interaction mode.

12. The system of claim 11 wherein the forwarding component forwards messages to an application in a way that the application is not aware that the system received and forwarded the user input.

13. The system of claim 10 further comprising a configuration component configured to receive configuration information from the user, and wherein the mode selection component is further configured to access the configuration information to determine which mode to select.

14. The system of claim 10 wherein the input device component comprises a touch screen and receives locations of the screen that the user touches.

15. A computer-readable medium encoded with instructions for controlling a computer system to indicate to a user the effect of selecting a particular displayed area, by a method comprising:
receiving a current location of a cursor;
determining whether the cursor is near a user interface element with which the user can interact;
when the cursor is over a user interface element with which the user can interact, modifying the cursor to display an element interaction cursor; and
when the cursor is not over a user interface element with which the user can interact, modifying the cursor to display a panning cursor.

16. The computer-readable medium of claim 15 wherein modifying the cursor to display an element interaction cursor comprises determining a cursor icon set by an application.

17. The computer-readable medium of claim 15 wherein modifying the cursor to display an element interaction cursor comprises determining a cursor icon set by an operating system.

18. The computer-readable medium of claim 15 wherein modifying the cursor to display a panning cursor comprises modifying the cursor to display an indication to the user that the user can pan by selecting the cursor location.

19. The computer-readable medium of claim 15 wherein determining whether the cursor is near the user interface element comprises determining whether the cursor overlaps with at least a portion of the user interface element.

20. The computer-readable medium of claim 15 wherein determining whether the cursor is near the user interface element comprises determining the distance from the center of the cursor to the center of the user interface element.
